(19) United States
(12) Patent Application Publication
(10) Pub. No.: US 2007/0087300 A1
(43) Pub. Date: Apr. 19, 2007

(54) Invisible spring aligner

(76) Inventors: Brian D. Willison, Tonawanda, NY (US); Donal P. Inman, Coral Springs, FL (US)

Correspondence Address: HODGSON RUSS LLP, ONE M & T PLAZA, SUITE 2000, BUFFALO, NY, 14203-2391, US

(21) Appl. No.: 11/489,115

(22) Filed: Jul. 19, 2006

Related U.S. Application Data
(60) Provisional application No. 60/700,671, filed on Jul. 20, 2005.

(51) Int. Cl. A61C 3/00

(52) U.S. Cl. 433/6

(57) ABSTRACT

An orthodontic appliance for positioning one or more anterior teeth in a jaw of a patient comprising a clear labial component which extends over the labial surfaces of the patient's teeth and which has an anterior portion and a pair of posterior portions on opposite sides of the dental arch. The anterior and posterior portions of the labial component are in direct contact with the exterior surfaces of the teeth so that no other components of the appliance are located between the anterior and posterior portions of the labial component and those exterior surfaces of the teeth. A lingual component is located within the patient's dental arch for supporting the appliance and for applying force to the patient's anterior teeth, the lingual component operating to move the anterior teeth against the anterior portion of the labial component which serves as a reference against which the teeth are positioned.

### CROSS REFERENCE TO A RELATED APPLICATION

Applicants claim priority based on U.S. Provisional Patent Application No. 60/700,671 filed Jul. 20, 2005 entitled “Invisible Spring Aligner” which is incorporated by reference.

### BACKGROUND OF THE INVENTION

This invention relates generally to orthodontic appliances, and more particularly to appliances for correction of problems specific to the anterior teeth.

Many variations of maxillary and mandibular removable tooth moving appliances exist. Some are referred to as orthodontic spring retainers, e.g. 3×3 Spring-Clip, Modified Design, Super Spring and Inman Aligner. Most of these designs are limited in the amount of tooth-movement that can be obtained from a single appliance. They also have cosmetic limitations, in that they have metal components on the facial surfaces of the teeth.

Removable, orthodontic retainer-like appliances typically contain wire clasps and frameworks for tooth alignment, which are placed along the lingual and labial tooth surfaces. Acrylic is applied to unite the frameworks and provide a secure foundation for controlled tooth-movement. All of these designs obtain their tooth-moving guidance from a dental reset of the patient's teeth.

The appliance shown in U.S. Pat. No. 6,435,871, known commercially as the Inman Aligner, provides superior tooth-moving potential relative to current designs. This appliance uses biasing means including coil springs to apply steady, gentle forces to teeth without the need for costly-multiple appliances to complete treatment. However, taking into account cosmetic considerations, some of the biasing means are located along visible portions of the tooth surfaces.

### SUMMARY OF THE INVENTION

It would, therefore, be highly desirable to provide a spring aligner orthodontic appliance having all the functional capabilities of the appliance of U.S. Pat. No. 6,435,871 with the added benefit of an invisible cosmetic advantage. The appliance of this invention includes a clear plastic component which has a posterior portion that extends over the labial surfaces of the teeth to provide a sufficiently strong and stable customized reference against which the teeth can be aligned, clarity for improved esthetics, enhanced retention of the appliance, and reduced need for retention adjustments. The anterior portion of the clear plastic component may comprise an elastic orthodontic chain, silicone, or other suitable clear material.

The appliance of this invention also includes a lingual component which operates as a piston-like device to move the anterior teeth against the clear plastic component. Variations of lingual component design may be used within the scope of this invention. This appliance is ideal for correction of incisor rotations, crowding, and adult relapse. It achieves controlled, continuous movement of the anterior teeth (2×2). This preprogrammed appliance makes adjustments virtually unnecessary. In most individuals, precision alignment can be accomplished with just one appliance.

The foregoing and additional advantages and characterizing features of the invention will become clearly apparent upon a reading of the ensuing detailed description together with the included drawing.

### BRIEF DESCRIPTION OF THE DRAWING FIGURES

FIG. 1 is a perspective view of a spring aligner orthodontic appliance according to the invention;

FIG. 2 is a front elevational view of one set of maxillary and mandibular models of a patient's dentition in the form sent to a laboratory for fabrication of the spring aligner appliance of the invention;

FIG. 3 is an enlarged front elevational view of another set of maxillary and mandibular models of a patient's dentition in the form sent to a laboratory for fabrication of the spring aligner appliance of the invention;

FIG. 4 is a front elevational view showing model surgery performed on the models of FIG. 2;

FIG. 5 is a front elevational view showing model surgery performed on the models of FIG. 3;

FIG. 6 is a top perspective view of a spring aligner appliance of the invention fabricated to a duplication of a reset model;

FIG. 7 is a side perspective view of the appliance of FIG. 6;

FIG. 8 is a perspective view of a spring aligner orthodontic appliance according to another embodiment of the invention for use on a patient's lower dental arch;

FIG. 9 is a perspective view of a variation of the spring aligner orthodontic appliance shown in FIG. 8 for use on a patient's upper dental arch;

FIG. 10 is a perspective view of a spring aligner orthodontic appliance according to the invention for use on a patient's upper and lower dental arches;

FIG. 11 is a perspective view of a spring aligner orthodontic appliance according to another embodiment of the invention;

FIG. 12 is an enlarged perspective view of the spring aligner orthodontic appliance of FIG. 11;

FIG. 13 is a side perspective view of the appliance of FIG. 11;

FIG. 14 is another perspective view of the appliance of FIG. 11;

FIG. 15 is a front and slightly elevated perspective view of the appliance of FIG. 11;

FIG. 16 is a perspective view similar to FIG. 15 and elevated slightly further;

FIG. 17 is an enlarged perspective view an alternative form of the appliance of FIG. 11; and

FIG. 18 is a view similar to FIG. 17 taken from the opposite side of the appliance.

### DETAILED DESCRIPTION OF THE INVENTION

Referring to FIG. 1, the appliance 10 of the invention includes a clear plastic labial component generally designated 12 which extends over the labial surfaces of the teeth and which has an anterior portion 14 and a pair of posterior portions 16 and 18, the posterior portions being on opposite sides of the dental arch. In the embodiment shown in FIG. 1, the anterior portion 14 and posterior portions 16, 18 comprise an integral or continuous plastic body. In accordance with this invention, anterior portion 14 and posterior portions 16, 18 are in direct contact with the labial/exterior surfaces of the teeth so that only those surfaces of the teeth are visible through the clear, substantially transparent plastic component 12 of the appliance. There is nothing between the labial/exterior surfaces of the teeth and the body of component 12. In other words, other than the clear plastic labial component 12 there are no other components of the appliance externally visible to an observer during normal jaw movements of the patient such as breathing, smiling, talking and eating.

Each of the posterior portions 16, 18 is in the form of a posterior cap which covers the crowns of the teeth. In particular, each posterior portion, for example portion 16, includes an outer wall 20 which extends along the labial/exterior surfaces of the teeth and toward the gums, a base or central wall 22 which extends inwardly from outer wall and covers or overlies the crown surfaces of the teeth and an inner wall 24 which extends from the base 22 and is joined to a lingual support component which will be described. Likewise, as shown in FIG. 1, posterior portion 18 includes outer wall 28, base 30 and inner wall 32.

The anterior portion 14 is in the form of a labial aligning strip which, in the embodiment shown in FIG. 1, is a clear plastic extension of the posterior caps 16, 18 to the labial areas of the anterior teeth. The strip includes a first edge 36 which extends laterally around the anterior portion of the dental arch spaced a short distance from the ends or tip edges of the anterior teeth. The strip includes a second edge 38 which extends substantially parallel to the first edge 36 and is near the gums of the anterior teeth. The strip includes a surface 40 which contacts the labial surfaces of the anterior teeth. Surface 40 can be smooth or, alternatively, can have an impression of the selected anterior teeth when they are in an ideal or desired post-treatment position and orientation.

By way of example, one form of clear, substantially transparent plastic material from which the labial component 12 can be formed is commercially available from Great Lakes Orthodontics, Ltd., Tonawanda, N.Y. under the designation Splint Biocryl. Other clear, substantially transparent thermoplastic materials can be employed, for example a copolyester-PETG commercially available under the designation Invisacryl-A and a polycarbonate commercially available under the designation Super Imprelon. Labial component 12 can be formed using a dental forming machine commercially available from Great Lakes Orthodontics, Ltd. under the designation Biostar. The component 12 is first molded on a model of the patient's dental arch using such a machine and thereafter trimmed, all in a manner well-known to those skilled in the art. By way of example, the labial component so formed preferably would have a thickness of about 1 mm. For a more detailed description of the Biostar machine and its method of operation, reference may be made to United States Patent No. 3,768,164 the disclosure of which is hereby incorporated by reference.

The appliance 10 of the invention further comprises a lingual component generally designated 50 which functions to support the appliance, and to apply force to or against the anterior teeth of the patient's dental arch, the lingual component operating to move the anterior teeth against the anterior portion of the labial component which, in turn, serves as a reference against which the teeth are aligned. In particular, the lingual component 50 comprises a supporting portion which is located within the patient's dental arch. One form of supporting portion as shown in FIG. 1 comprises a pair of supporting bodies 52, 54 of hardened acrylic or like material located on opposite lingual surfaces of the patient's posterior dentition which bodies are joined by a lingual stabilizing bar 56. An example of the material for supporting bodies 52,54 is commercially available from Great Lakes Orthodontics, Ltd. under the designation Biocryl Acrylic Resin (Methyl Methacrylate). The laterally opposed supporting bodies 52 and 54 are bonded to the posterior portions 16 and 18, respectively, of labial component 12 to provide retention and support thereof. Lingual stabilizing bar 56 is in the form of a metal wire and serves to reduce the amount of lingual plastic needed near the anterior segment of the appliance. Bar 56 is curved to correspond to the anterior portion of the dental arch, the curved portion extending generally laterally within the dental arch, and the ends of bar 56 are anchored into the anterior—facing ends of the supporting bodies 52, 54. By way of example, bar 56 can be of stainless steel or chrome cobalt material. In lieu of stabilizing bar 56, the supporting portion of lingual component 50 can comprise a single or unitary structure including the plastic supporting bodies 52, 54 joined by an integral plastic supporting component extending from bodies 52, 54 generally laterally within the dental arch near the anterior region thereof.

The force applying portion of lingual component 50 functions to apply force against one or more of the anterior teeth of the patient's dental arch. In particular, the force applying portion of lingual component 50 operates to move one or more of the anterior teeth against the anterior portion 14 of labial component 12 which, in turn, serves as a reference against which the teeth are aligned. The force applying portion of lingual component 50 comprises a lingual pad 60 of hardened acrylic or like material which is custom-formed for the particular patient according to the specified resetting of that patient's anterior teeth. In particular, pad 60 has a lingual contact surface (not shown) which can be provided with an impression of the lingual surfaces of the targeted anterior teeth with those teeth in the ideal or desired post-treatment position and orientation. Pad 60 contacts the lingual surfaces of the anterior teeth as shown in FIG. 1 for directing the applied force. By way of example, pad 30 can be of the same material as the supporting bodies 52,54.

The force applying portion also comprises a force-generating mechanism in the form of a lingual rod or wire 66 embedded in or otherwise fixed to pad 60 and having a pair of ends 68 and 70 extending into the lingual supporting bodies 52 and 54, respectively, and force-applying coil springs 72 and 74 on wire 66. Wire 66 can comprise a standard 0.030 inch diameter spring hard wire including a mid section which can be curved in accordance with the anterior portion of the dental arch and embedded in lingual pad 60. By way of example, wire 66 can be of stainless steel or chrome cobalt material. The ends 68 and 70 of lingual wire 66 are received in tubes 78 and 80, respectively, which are embedded in the lingual supporting bodies 52 and 54, respectively. Tubes 78, 80 each can comprise conventional 0.040 inch diameter stainless steel tubing, and each tube includes a forward end having an opening sized and shaped for slidably receiving the distal extending ends 68, 70 of rod 66. The coil springs 72, 74, which can be open coil NiTi spring wire, exert the proper tooth-moving forces, as determined by the orthodontist, to the anterior dentition. In particular, one end of each spring 72 and 74 abuts an end of a corresponding one of the sleeves or tubes 78 and 80, respectively, and the opposite end of each spring abuts the pad 60. Accordingly, each spring 72, 74 is maintained in a compressed state between the corresponding sleeve and pad 60 thereby urging pad 60 in an anterior or forward direction. The magnitude of the force applied by the lingual component 50 of the appliance can be adjusted easily by incorporating springs having the particular desired compressive properties and/or by modifying the lengths of the springs. As an alternative, coil springs 72,74 can be of stainless steel or chrome cobalt material.

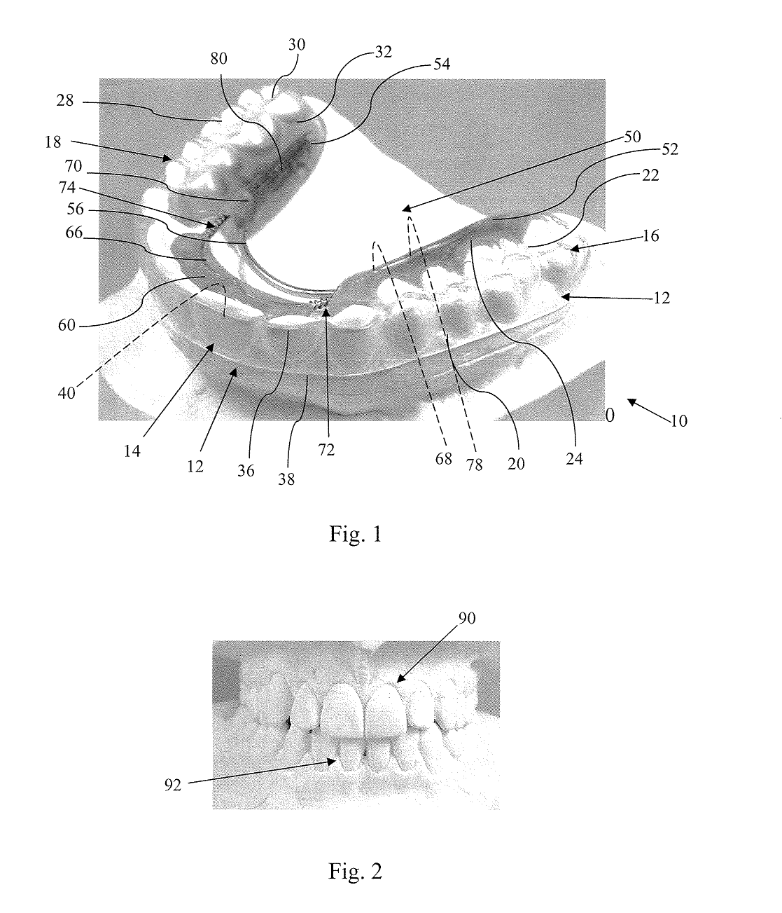

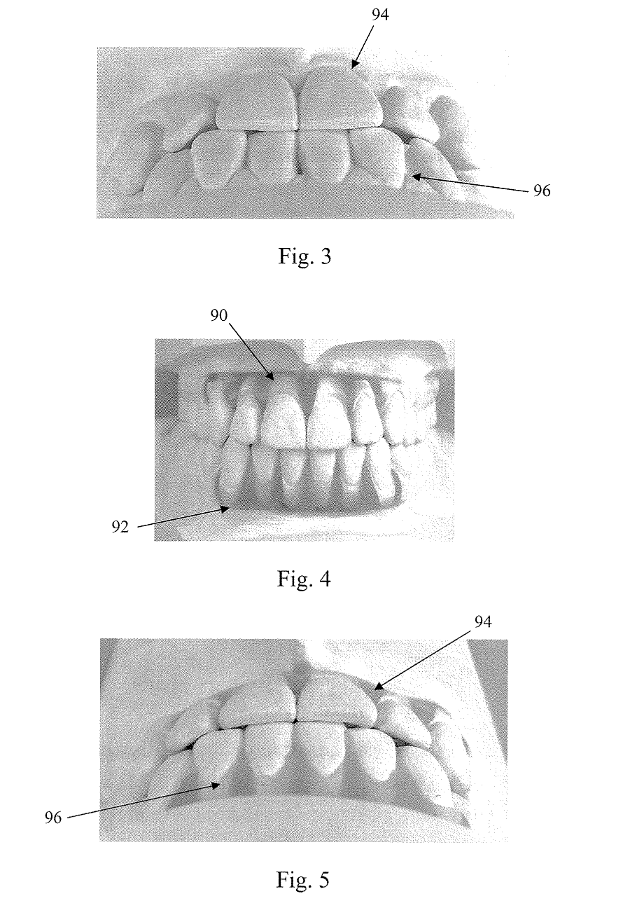

Prior to fabricating the appliance, a dental cast of the patient's teeth is created using a hardenable refractory material as is well known to those skilled in the art. For example, FIG. 2 shows one set of maxillary 90 and mandibular 92 models of a patient's dentition, and FIG. 3 shows another set of maxillary 94 and mandibular 96 models of a patient's dentition. The anterior teeth targeted for treatment are removed from the cast and then reset on the cast with wax in the desired post-treatment position and orientation. This procedure, often referred to as model surgery, is well-known to those skilled in the art. FIG. 4 shows the results of model surgery performed on the models of FIG. 2 wherein the anterior teeth have been cut from the original models and then repositioned to perfect alignment, i.e. reset. Similarly, FIG. 5 shows the results of model surgery performed on the models of FIG. 3 wherein the anterior teeth have been cut from the original models and then repositioned to perfect alignment, i.e. reset.

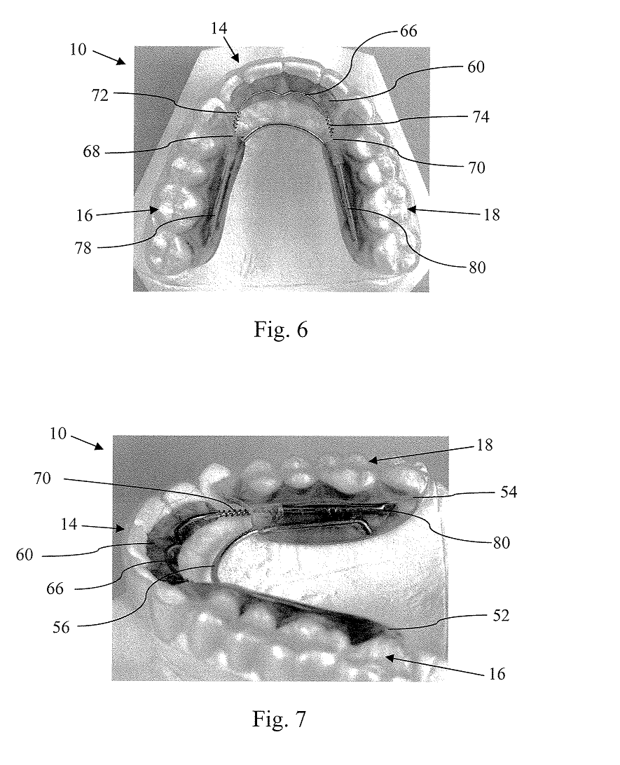

The appliance of the invention, shown in FIG. 1 and in the additional views of FIGS. 6 and 7, is fabricated to duplication of a reset model, for example the reset models of FIGS. 4 and 5. Fabrication of the labial component 12 of the appliance using, for example, a Biostar dental forming machine, was described hereinabove. In particular, after the sheet of thermoplastic material is thermoformed on the teeth of the reset model, the plastic material is trimmed to define the labial component of the labial component 12 including the anterior portion 14 and posterior portions 16, 18. Fabrication and assembly of the parts of the lingual component 50 including supporting bodies 52, 54, stabilizing bar 56, pad 60, lingual wire 66, coil springs 72, 74 and sleeves 78, 80 also has been described hereinabove and should be readily apparent to those skilled in the art. In this connection, reference may be made to the aforesaid Pat. No. 6,435,871 the disclosure of which is hereby incorporated by reference.

The appliance 10 of the invention is shown in FIGS. 1, 6 and 7 operatively associated with the dental arch of a patient's lower jaw. The appliance 10 functions in a similar manner in the dental arch of a patient's upper jaw. In that case the supporting bodies 52, 54 can be joined by a plastic palatal extension which will be shown and described presently. The provision of such a palatal portion or extension would obviate the need for lingual stabilizing bar 56.

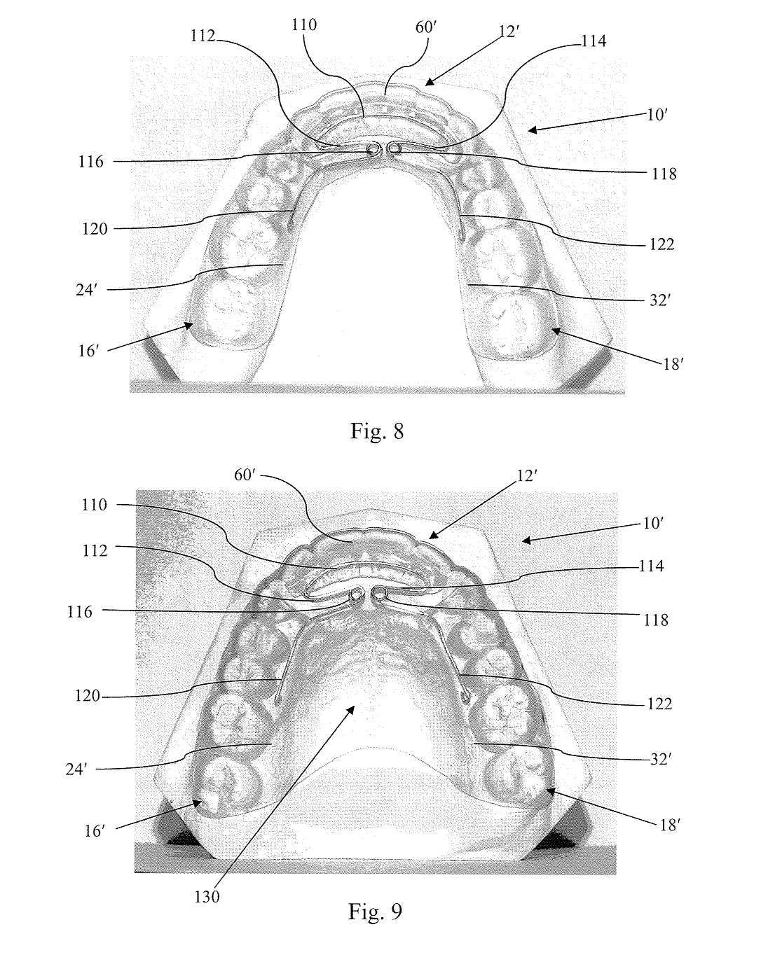

FIGS. 8 and 9 show an appliance 10′ according to another embodiment of the invention. Referring first to FIG. 8 which shows a form of the appliance for use in a patient's lower jaw there is provided a labial component 12′ substantially similar to labial component 12 in the embodiment of FIGS. 1, 6 and 7. Accordingly those similar components are identified by the same reference numeral but with a prime designation. In the labial component 12′ of this embodiment, the inner walls 24′ and 32′ of portions 16′ and 18′, respectively, extend deeper into the patient's dental arch toward the gingival margin. These extended inner walls 24′ and 32′ merge into and serve as the supporting portion of the lingual component in this embodiment. The force applying portion of the lingual component can include a lingual pad 60′ substantially similar to pad 60 in the embodiment of FIGS. 1, 6 and 7. However, in this embodiment the remainder of the force applying portion includes a lingual rod or wire having a midsection formed generally in the shape of a mushroom 110 which is embedded in or otherwise fixed to lingual pad 60′ and a pair of sections 112 and 114 extending out from pad 60′ each including a coil portion 116 and 118, respectively, and a pair of ends 120 and 122 embedded or otherwise fixed in the walls 24′ and 32′, respectively. The lingual rod can comprise spring wire, for example 0.028 inch diameter spring hard wire. The spring characteristics of the wire together with the nature of the adjustable coil portions 116 and 118 determine the magnitude of the force applied through pad 60′ to the anterior teeth. The ends 120 and 122 can be hook-shaped as shown in FIG. 8 to enhance retention in walls 24′ and 32′, respectively.

The appliance shown in FIG. 9 is for use in a patient's upper jaw. It incorporates the features of the embodiment of FIG. 8 and is identical thereto with the addition of the palatal portion 130 which is integrally formed with the posterior portions 16′, 18′ and is shaped to conform to the patient's palate. The appliances of FIGS. 8 and 9 are formed in a manner similar to that described in connection with the appliance of FIGS. 1, 6 and 7.

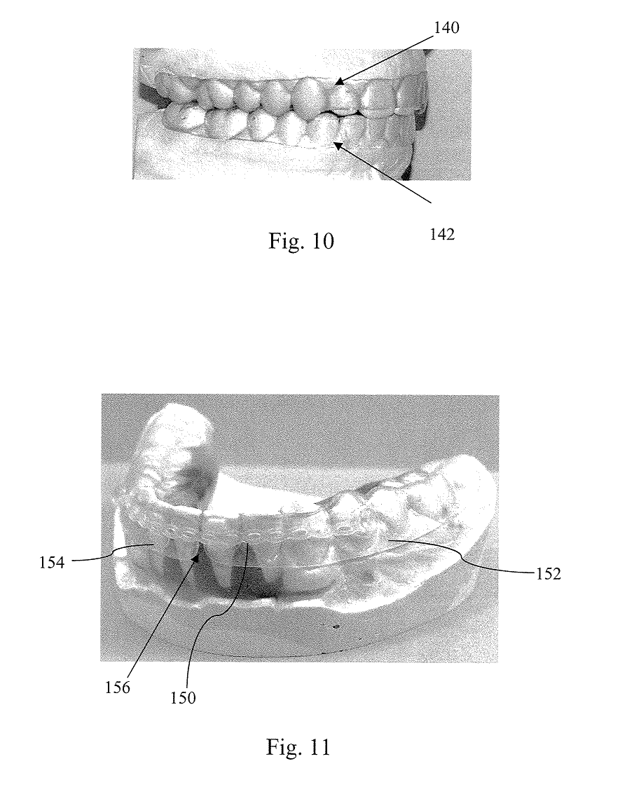

FIG. 10 shows a spring aligner orthodontic appliance according to the invention for use on a patient's upper and lower dental arches. The upper part 140 of the appliance includes a labial component having an anterior portion and a pair of posterior portions together with a lingual component including force applying means. The upper 140 part can comprise the appliance shown in FIGS. 1, 6 and 7 including the described palatal extension or can comprise the appliance shown in FIG. 9. Likewise the lower part 142 of the appliance includes a labial component having an anterior portion and a pair of posterior portions together with a lingual component including force applying means. The lower part 142 can comprise the appliance shown in FIGS. 1, 6 and 7 or can comprise the appliance shown in FIG. 8.

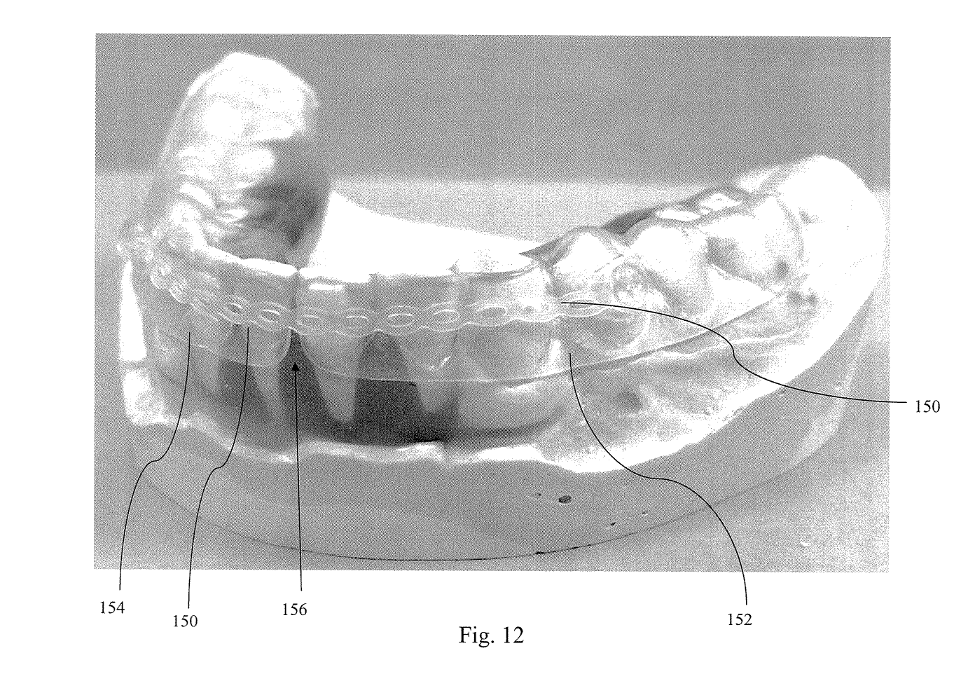

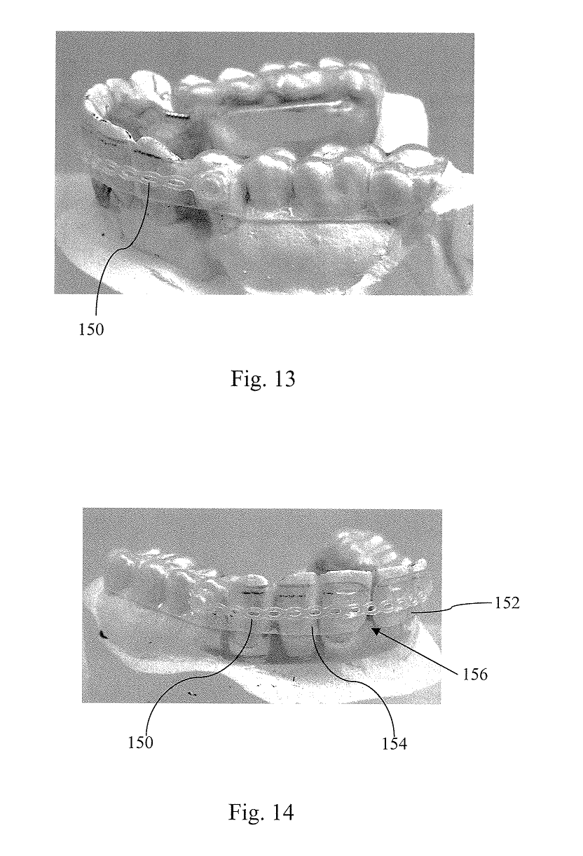

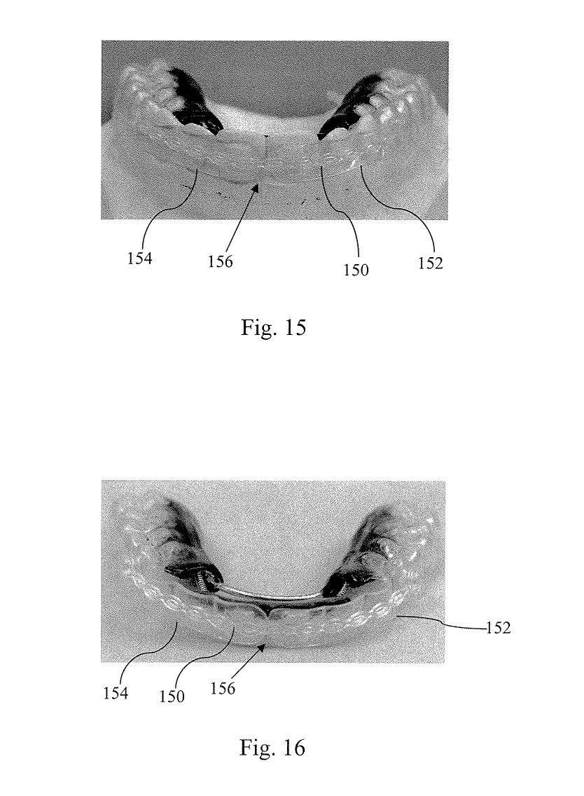

FIGS. 11-16 show a spring aligner orthodontic appliance according to another embodiment of the invention. In this embodiment, the anterior portion of the labial component includes an elastic orthodontic chain designated 150. Chain 150 is of plastic material and bonded or otherwise joined at its opposite ends to the labial component, for example at or near the junctions of the strip-like anterior portion and the posterior portions. In this embodiment, the anterior strip is separated into two sections designated 152 and 154 which define a small gap 156 between their ends to accommodate the elastic action of chain 150. The remainder of the appliance can have the form of either the embodiment of FIGS. 1, 6 and 7 or the embodiments of FIGS. 8 and 9.

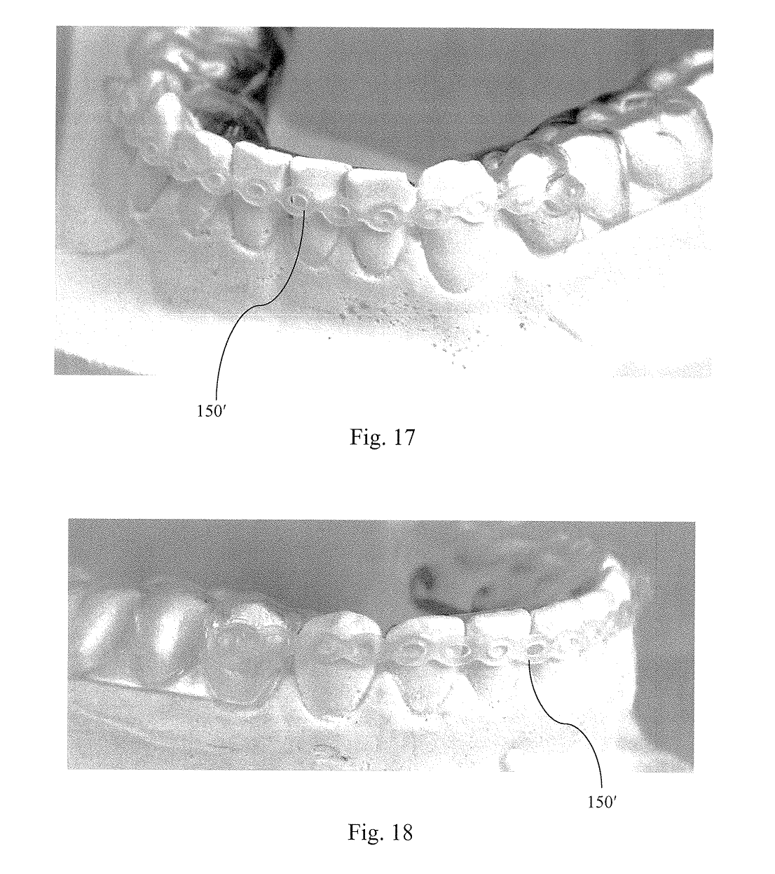

An alternative to the appliance of FIGS. 11-16 is shown in FIGS. 17 and 18 wherein the anterior portion of the labial component comprises only the elastic orthodontic chain 150′. Chain 150′ is bounded or otherwise joined at its opposite ends to the posterior portions of the labial component. By way of example, chain 150/150′ can comprise a power chain of urethane, EVA or silicone material such as the clear power chain commercially available from ORMCO under the designation 639-0002. Clear elastic tubing, clear rubber band elastics and the like also can be employed.

It is therefore apparent that the invention accomplishes its intended objectives. While embodiments of the invention have been described in detail, that is done for the purpose of illustration, not limitation.

1. An orthodontic appliance for positioning one or more anterior teeth in a jaw of a patient comprising:
a) a clear labial component which extends over the labial surfaces of the patient's teeth when the appliance is installed in the jaw of the patient and which has an anterior portion and a pair of posterior portions, the posterior portions being on opposite sides of the dental arch;
b) the anterior and posterior portions of the labial component being in direct contact with the exterior surfaces of the teeth so that no other components of the appliance are located between the anterior and posterior portions of the labial component and said exterior surfaces of the teeth; and
c) a lingual component to be located within the patient's dental arch for supporting the appliance and for applying force to the patient's anterior teeth, the lingual component operating to move the anterior teeth against the anterior portion of the labial component which serves as a reference against which the teeth are positioned.

2. An orthodontic appliance according to claim 1, wherein each of the posterior portions of the labial component includes an outer wall which extends along the labial/exterior surfaces of the teeth and toward the gums, a base wall which extends inwardly from the outer wall and overlies the crown surfaces of the teeth and an inner wall which extends from the base wall.

3. An orthodontic appliance according to claim 1, wherein the anterior portion of the labial component is in the form of a strip having a first edge located near the tip edges of the anterior teeth and a second edge located near the gums.

4. An orthodontic appliance according to claim 2, wherein the lingual component includes a pair of supporting bodies fixed to the inner walls of the posterior portions of the labial component and force applying means between the supporting bodies and the anterior teeth.

5. An orthodontic appliance according to claim 4, wherein the force applying means includes a pad for contacting lingual surfaces of the anterior teeth and spring means between the supporting bodies and the pad for urging the pad against the anterior teeth.

6. An orthodontic appliance according to claim 2, wherein the inner walls of the posterior portions of the labial component extend along the lingual/interior surfaces of the teeth and wherein force applying means extends between the inner walls and the anterior teeth.

7. An orthodontic appliance according to claim 6, wherein the force applying means includes a pad for contacting lingual surfaces of the anterior teeth and spring means between the inner walls of the posterior portions and the pad for urging the pad against the anterior teeth.

8. An orthodontic appliance according to claim 1, wherein the anterior portion of the labial component includes an elastic orthodontic chain.

9. A pair of orthodontic appliances according to claim 1, each including said labial component and said lingual component, one of the appliances being for installation on the patient's lower dental arch and the other appliance being for installation on the patient's upper dental arch.

10. An orthodontic appliance for positioning one or more anterior teeth in a jaw of a patient comprising:
a) a clear labial component which extends over the labial surfaces of the patient's teeth when the appliance is installed in the jaw of the patient and which has an anterior portion and a pair of posterior portions, the anterior portion being in the form of a strip extending across the anterior teeth and the posterior portions being on opposite sides of the dental arch, each of the posterior portions including an outer wall which extends along the labial/exterior surfaces of the teeth and toward the gums, a base wall which extends inwardly from the outer wall and overlies the crown surfaces of the teeth and an inner wall which extends from the base wall;
b) the anterior and posterior portions of the labial component being in direct contact with the exterior surfaces of the teeth so that no other components of the appliance are located between the anterior and posterior portions of the labial component and said exterior surfaces of the teeth and so that no other components of the appliance are visible to an observer during normal jaw movements of the patient including breathing, smiling, talking and eating;
and
c) a lingual component to be located within the patient's dental arch and including means for applying force to the patient's anterior teeth, the force applying means of the lingual component operating to move the anterior teeth against the anterior portion of the labial component which serves as a reference against which the teeth are positioned.

11. An orthodontic appliance according to claim 10, wherein the lingual component includes a pair of supporting bodies fixed to the inner walls of the posterior portions of the labial component and wherein the force applying means is between the supporting bodies and the anterior teeth.

12. An orthodontic appliance according to claim 11, wherein the force applying means includes a pad for contacting lingual surfaces of the anterior teeth and spring means between the supporting bodies and the pad for urging the pad against the anterior teeth.

13. An orthodontic appliance according to claim 10, wherein the inner walls of the posterior portions of the labial component extend along the lingual/interior surfaces of the teeth and wherein the force applying means extends between the inner walls and the anterior teeth.

14. An orthodontic appliance according to claim 13, wherein the force applying means includes a pad for contacting lingual surfaces of the anterior teeth and spring means between the inner walls of the posterior portions and the pad for urging the pad against the anterior teeth.

15. An orthodontic appliance according to claim 10, wherein the anterior portion of the labial component includes an elastic orthodontic chain.

16. A pair of orthodontic appliances according to claim 10, each including said labial component and said lingual component, one of the appliances being for installation on the patient's lower dental arch and the other appliance being for installation on the patient's upper dental arch.

17. A method of making an orthodontic appliance for positioning one or more anterior teeth in a jaw of a patient, the method comprising:
a) providing a model of the dental arch of a patient wherein one or more of the anterior teeth have been reset to a desired position;
b) providing a sheet of clear thermoplastic material;
c) thermoforming the plastic material on the teeth of the model of the dental arch;
d) trimming the plastic material to define a clear labial component of the appliance which extends over the labial surfaces of the patient's teeth when the appliance is installed in the jaw of the patient and which has an anterior portion and a pair of posterior portions, the anterior portion being in the form of a strip extending across the anterior teeth and the posterior portions being on opposite sides of the dental arch, each of the posterior portions including an outer wall which extends along the labial/exterior surfaces of the teeth and toward the gums, a base wall which extends inwardly from the outer wall and overlies the crown surfaces of the teeth and an inner wall which extends from the base wall;
e) providing a lingual component to be located within the patient's dental arch and including means for applying force to the patient's anterior teeth, the force applying means of the lingual component operating to move the anterior teeth against the anterior portion of the labial component which serves as a reference against which the teeth are positioned; and
f) so that when the appliance is installed in the patient's jaw the anterior and posterior portions of the labial component are in direct contact with the exterior surfaces of the teeth so that no other components of the appliance are located between the anterior and posterior portions of the labial component and said exterior surfaces of the teeth and so that no other components of the appliance are visible to an observer during normal jaw movements of the patient including breathing, smiling, talking and eating.
